(19) United States
(12) Patent Application Publication
(10) Pub. No.: US 2004/0208012 A1
(43) Pub. Date: Oct. 21, 2004

(54) Illuminating door device

(76) Inventor: Ming-Cheng Wang, Taichung (TW)

Correspondence Address: Ming-Cheng Wang, 58, MA YUAN WEST ST., TAICHUNG, TW

(21) Appl. No.: 10/418,978

(22) Filed: Apr. 18, 2003

(51) Int. Cl. B60Q 1/00

(52) U.S. Cl. 362/487

(57) ABSTRACT

An illuminating door device has an illuminating article disposed on a vehicle. The illuminating article is a door escutcheon. A plurality of light-emitting diodes are disposed in the illuminating door escutcheon. The illuminating door escutcheon is made of a fluorescent material.

### BACKGROUND OF THE INVENTION

The present invention relates to an illuminating door device. More particularly, the present invention relates to an illuminating door device of a vehicle.

A conventional door handle of a vehicle cannot produce light. A pedestrian does not watch an approaching car at night while the pedestrian walks by the side of the car. Therefore, a traffic accident may occur.

### SUMMARY OF THE INVENTION

An object of the present invention is to provide an illuminating door device which will illuminate light at night so that a pedestrian will watch an approaching car having the illuminating door device while the pedestrian walks by the side of the car.

Accordingly, an illuminating door device has an illuminating article disposed on a vehicle.

In accordance with a first preferred embodiment of the present invention, an illuminating door device is disposed on a vehicle. The illuminating door device comprises an illuminating door handle.

In accordance with a second preferred embodiment of the present invention, an illuminating door device is disposed on a car. The illuminating door device comprises an illuminating door escutcheon.

In accordance with a third preferred embodiment of the present invention, an illuminating door device comprises an illuminating door escutcheon. A cold light plate is disposed in the illuminating door escutcheon.

In accordance with a fourth preferred embodiment of the present invention, an illuminating door device comprises an illuminating door escutcheon. A plurality of light-emitting diodes are disposed in the illuminating door escutcheon.

### BRIEF DESCRIPTION OF THE DRAWINGS

FIG. 1 is an elevational schematic view of an illuminating door device of a first preferred embodiment disposed on a vehicle;

FIG. 1A is an elevational view of an illuminating door device of a first preferred embodiment in accordance with the present invention;

FIG. 2 is an elevational schematic view of an illuminating door device of a second preferred embodiment disposed on a car;

FIG. 2A is an elevational view of an illuminating door device of a second preferred embodiment in accordance with the present invention;

FIG. 3 is a sectional view of an illuminating door device of a third preferred embodiment having a cold light plate therein;

FIG. 4 is a sectional view of an illuminating door device of a fourth preferred embodiment having a plurality of light-emitting diodes therein;

FIG. 5 is a sectional view of an illuminating door device of a fifth preferred embodiment having a mark therein; and

FIG. 6 is a sectional view of an illuminating door device of a sixth preferred embodiment having a mark therein.

### DETAILED DESCRIPTION OF THE INVENTION

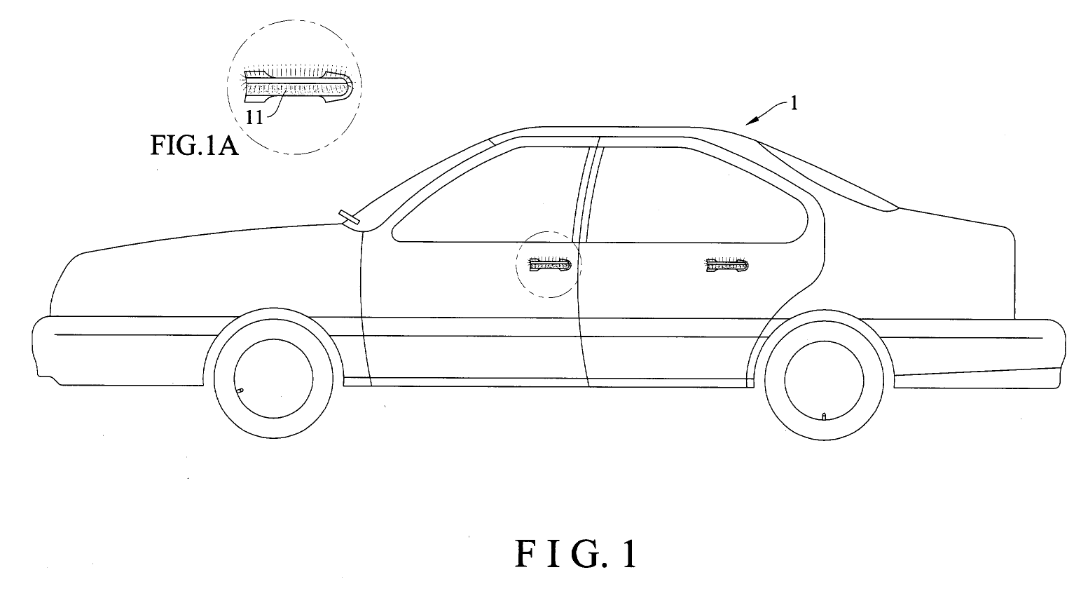

Referring to FIGS. 1 and 1A, a first illuminating door device is disposed on a vehicle 1.

The first illuminating door device comprises a first illuminating door handle 11.

It is an option that the illuminating door handle 11 is made of a fluorescent material. The fluorescent material absorbs a solar energy in the daytime and emits light at night.

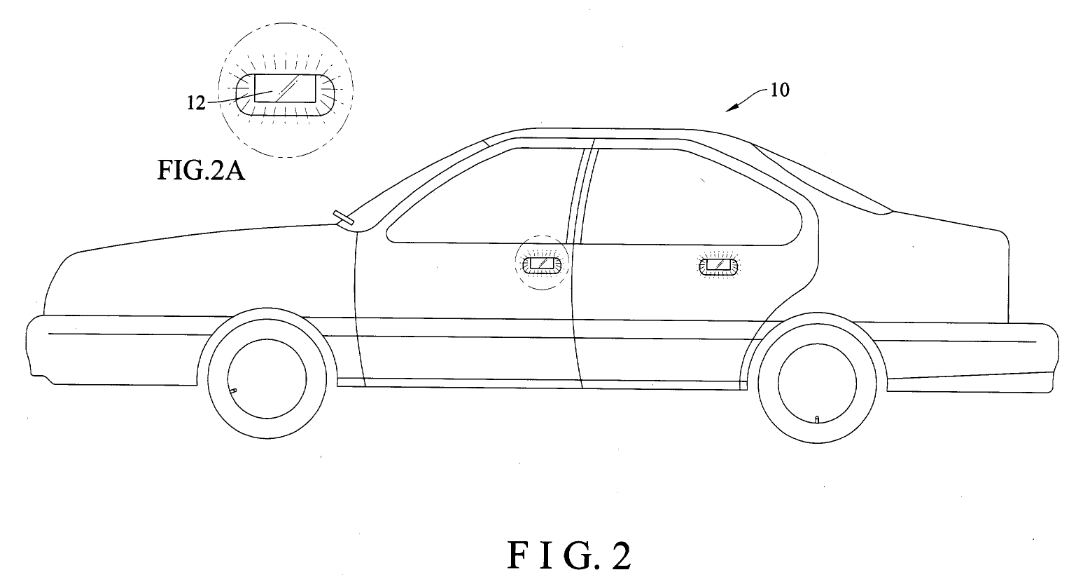

Referring to FIGS. 2 and 2A, a second illuminating door device is disposed on a car 10.

The second illuminating door device comprises a first illuminating door escutcheon 12.

It is an option that the first illuminating door escutcheon 12 is made of a fluorescent material.

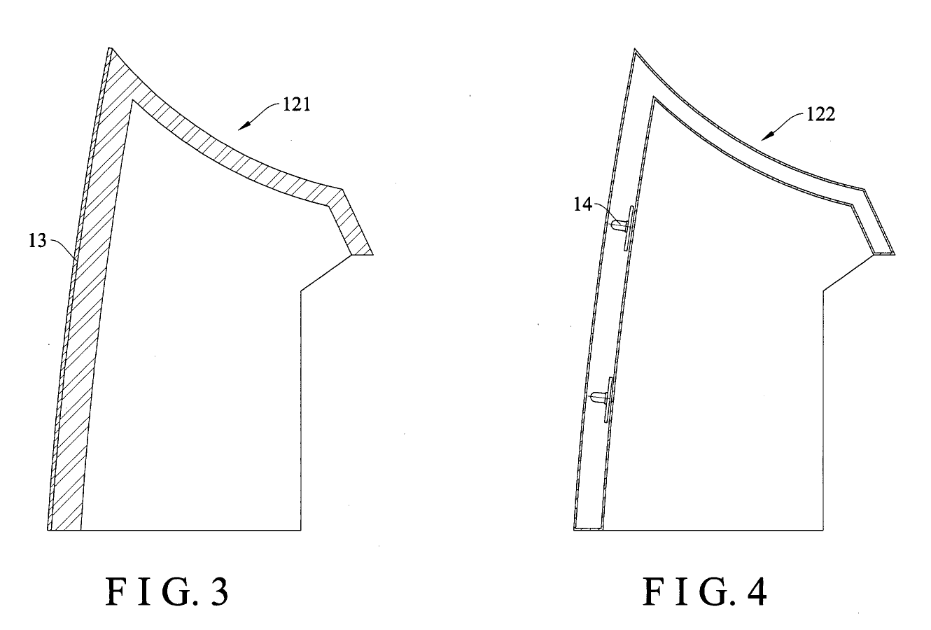

Referring to FIG. 3, a third illuminating door device comprises a second illuminating door escutcheon 121.

A cold light plate 13 is disposed in the second illuminating door escutcheon 121.

It is an option to use an electric source of a head lamp as the electric source of the cold light plate 13.

Referring to FIG. 4, a fourth illuminating door device comprises a third illuminating door escutcheon 122.

A plurality of light-emitting diodes 14 are disposed in the third illuminating door escutcheon 122.

It is an option to use an electric source of a head lamp as the electric source of the light-emitting diodes 14.

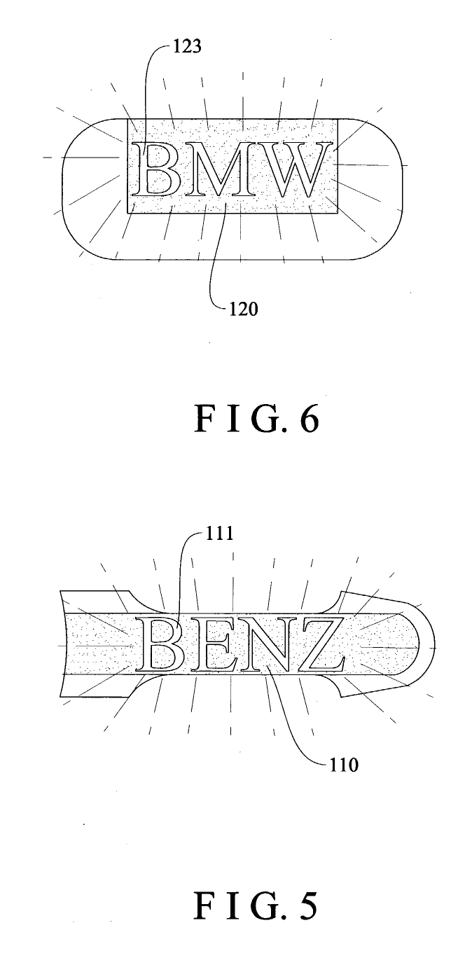

Referring to FIG. 5, a mark 111 is disposed on a second illuminating door handle 110.

Referring to FIG. 6, a mark sign 123 is disposed on a fourth illuminating door escutcheon 120.

The invention is not limited to the above embodiment but various modification thereof may be made. Further, various changes in form and detail may be made without departing from the scope of the invention.

I claim:

1. An illuminating door device having:
an illuminating article disposed on a vehicle.

2. The illuminating door device as claimed in claim 1, wherein the illuminating article is an illuminating door escutcheon.

3. The illuminating door device as claimed in claim 2, wherein the illuminating door escutcheon is made of a fluorescent material.

4. The illuminating door device as claimed in claim 2, wherein a cold light plate is disposed in the illuminating door escutcheon.

5. The illuminating door device as claimed in claim 2, wherein a plurality of light-emitting diodes are disposed in the illuminating door escutcheon.

6. The illuminating door device as claimed in claim 2, wherein a mark sign is disposed on the illuminating door escutcheon.

7. The illuminating door device as claimed in claim 1, wherein the illuminating article is an illuminating door handle.

8. The illuminating door device as claimed in claim 7, wherein the illuminating door handle is made of a fluorescent material.

9. The illuminating door device as claimed in claim 7, wherein a mark is disposed on the illuminating door handle.
